(19) United States
(12) Patent Application Publication
(10) Pub. No.: US 2003/0145097 A1
(43) Pub. Date: Jul. 31, 2003

(54) Ingress throttling via adaptive interrupt delay scheduling

(76) Inventors: Patrick L. Connor, Portland, OR (US); Daniel R. Gaur, Beaverton, OR (US); Eric K. Mann, Hillsboro, OR (US); Gary Y. Tsao, Austin, TX (US); Michael C. Gibson, Austin, TX (US)

Correspondence Address: PILLSBURY WINTHROP, LLP, P.O. BOX 10500, MCLEAN, VA, 22102, US

(21) Appl. No.: 10/055,922

(22) Filed: Jan. 28, 2002

(51) Int. Cl. G06F 15/16

(52) U.S. Cl. 709/232; 709/253

(57) ABSTRACT

An arrangement is provided for ingress throttling via adaptive interrupt delay scheduling. When packets are received, a receive interrupt is issued with a delay determined based on the backlog information of an associated host, gathered from the number of packets returned from the host after the completion of processing previously delivered packets.

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

Aspects of the present invention relate to communications. Other aspects of the present invention relate to packet receive interruption.

Physical devices in a computer system frequently use an “interrupt” mechanism to notify the occurrence of certain events. For instance, an I/O controller might generate an interrupt upon successfully transmitting a packet or upon receiving an incoming packet. Most I/O controllers, such as Ethernet Media Access Controllers (MACs), use interrupts as a means of notifying the arrival of incoming packets. An I/O controller may be capable of receiving tens or hundred of thousands of packets per second. Typically, an I/O controller generates a “receive interrupt” after a new packet is received from the network. The interrupt may trigger an “interrupt handler” to process the newly-arrived packet(s). The interrupt handler may then verify the cause of the interrupt and then perform necessary post-interrupt operations.

Modern processors are usually optimized for processing streams of data, such as the data sent and received over a network connection. To better process data streams, processors internally overlap arithmetic and memory operations. To implement this overlapped execution, the processor has a data processing ‘pipeline’ comprising a plurality of pipeline stages. Interrupts force the processor to stop, cancel and drain its internal pipeline, thereby disrupting existing processing. Frequent disruptions may reach such a level that the processor can process only a small portion (if any) of received data. In effect, system data throughput can be drastically reduced.

To improve ‘system throughput’, a system may incorporate faster I/O devices. However, faster I/O devices can create even more interrupts. Alternatively, a system may be made to process data more efficiently by adding more stages to the processor pipeline. Unfortunately, neither of these approaches directly addresses the problem of tuning the interaction between the I/O controller and the processor.

The pathology of a system that spends majority of its time processing receive interrupts, which are subsequently dropped, is referred to as livelock. A primary cause of livelock is often an interrupt storm referring to a rapid succession of interrupts that preempts other tasks. Under heavy sustained network loads, interrupt storms can occur, leaving upper layers in a processing pipeline starved for CPU cycles. When such starved layers are no longer able to buffer packets, they subsequently drop the packets. Therefore, even though a high level of ingress throughput may be observed at the outset, the final consumer may see little or no throughput at all.

To alleviate this problem, some high-speed I/O controllers implement a method of receive (ingress) interrupt moderation to improve the efficiency of interrupts asserted to the processor. This allows for a single interrupt to signal more than one received packet based on the load situation at the lowest layer (network and/or device driver). FIG. 1 illustrates a framework 100 that employs the solution. I/O controller 110 sends receive interrupts to a host 140 via a bus 130. To avoid interrupt storms, the I/O controller employs a load-based interrupting mechanism 120 that moderates the receive interrupt according to the load situation. Upon receiving ingress interrupts, the protocol stack 150 in the host 140 processes the received packets.

With this solution, under a heavy load situation, packets can be possibly dropped at any layer of the protocol stack 150. Particularly, when a higher layer drops packets, valuable resources may be wasted. For example, if the host 140 performs all necessary processing to deliver a packet to a higher layer of the protocol stack 150, such as TCP/IP, and then such packets are ultimately dropped, multiple system resources are wasted, including the bus bandwidth used to transfer the packet, the CPU cycles associated with handling the receive interrupts, and any operations, such as checksum verification and decryption, performed by the layers prior to the layer where the packets are dropped.

### BRIEF DESCRIPTION OF THE DRAWINGS

The present invention is further described in terms of exemplary embodiments, which will be described in detail with reference to the drawings. These embodiments are non-limiting exemplary embodiments, in which like reference numerals represent similar parts throughout the several views of the drawings, and wherein:

FIG. 1 (prior art) illustrates a framework, in which each receive interrupt sent from an I/O controller representing a plurality of packets is determined based on packet load;

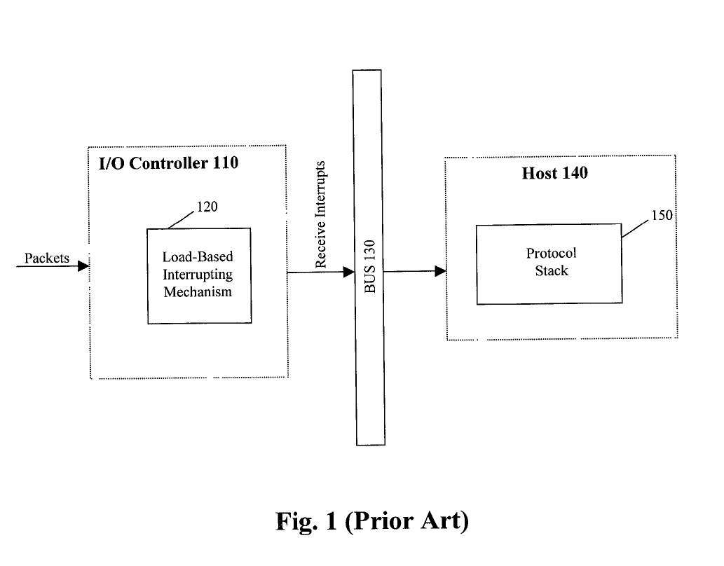

FIG. 2 depicts a framework, in which a receive interrupt from an I/O controller to a host is sent with a delay computed based on backlog situation of the host, according to embodiments of the present invention;

FIG. 3 depicts internal structures of an I/O controller in relation to a host that provides backlog information for the I/O controller to determine an interrupt delay, according to embodiments of the present invention;

FIG. 4 is an exemplary flowchart of a process, in which an I/O controller and a host communicate about received packets via a receive interrupt with a delay that is adaptively adjusted based on the backlog situation of the host, according to embodiments of the present invention;

FIG. 5 is an exemplary flowchart of a process, in which an I/O controller adaptively determines a delay in sending a receive interrupt to a host based on the backlog situation of the host, according to embodiments of the present invention;

FIG. 6 is an exemplary flowchart of a process, in which a host processes packets upon intercepting a receive interrupt and returns processed packets;

FIG. 7 is an exemplary plot of a plurality of constant functions, each of which represents a delay function within a particular backlog zone, according to an embodiment of the present invention; and

FIG. 8 is an exemplary plot of a plurality of linear functions, each of which represents a delay function within a particular backlog zone, according to an embodiment of the present invention.

### DETAILED DESCRIPTION

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software or firmware being run by a general-purpose or network processor. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

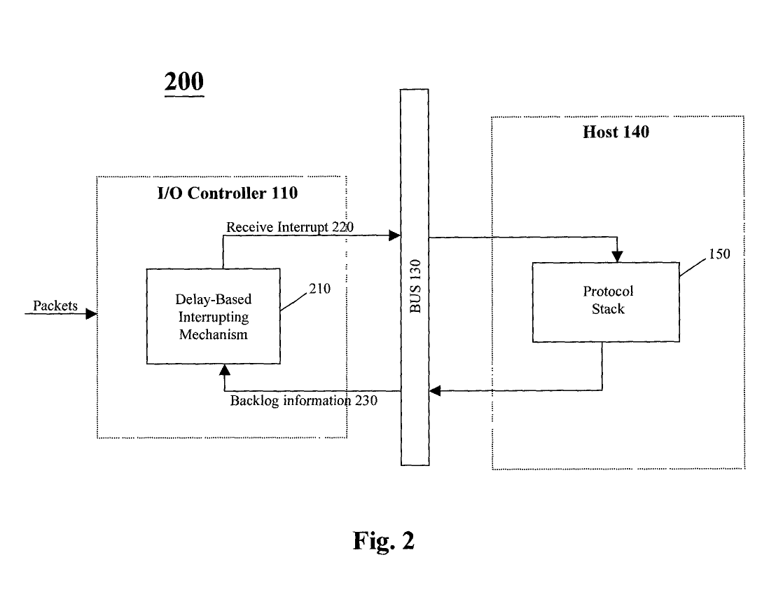

FIG. 2 depicts a framework 200, in which a receive interrupt 220 from an I/O controller 110 to a host 140 is sent with a delay computed based on backlog information 230 from the host, according to embodiments of the present invention. The framework 200 comprises an I/O controller 110, a host 140, and a bus 130 through which the I/O controller 110 and the host 140 send information to each other. The I/O controller 110 is responsible for receiving packets, for notifying the host 140 about received packets, and for sending the received packets to the host 140 for further processing. Upon being notified by the I/O controller 110, the host 140 processes the received packets sent from the I/O controller 110 and notifies the I/O controller 110 whenever the processing of a received packet is completed. To notify the host 140, the I/O controller 110 sends a receive interrupt 220 via the bus 130.

Upon receiving packets, the I/O controller 110 stores the received packets in buffers. It then, at an appropriate time, notifies the host 140 about the received packets by asserting receive interrupt 220. When the host 140 completes its processing of a packet, to return the packet to the I/O controller to signal its completion, it may not necessarily send the packet back to the I/O controller 110. Instead, it may simply notify the I/O controller 110 of which packet has been processed. Through this mechanism, the I/O controller 110 is aware of the progress of the host 140 with respect to processing the received packets. That is, the I/O controller 110 knows how many packets have been processed and how many packets that are still backlogged in the host 140, waiting to be processed.

The I/O controller 110 and the host 140 may operate asynchronously. The I/O controller 110 may keep receiving and buffering packets while the host 140 is processing the packets that are handed over previously. To determine when it is appropriate to indicate the packets so far received, the I/O controller 110 employs a backlog-based interrupting mechanism 210. The backlog-based interrupting mechanism 210 determines an appropriate time to notify the host 140 (about the received packets that are buffered) by asserting receive interrupt 220 to the host 140.

The appropriate time may be computed as the present time plus a delay. The backlog-based interrupting mechanism 210 computes such a delay according to the present backlog situation on the host 140. Present backlog situation may be assessed based on, for instance, the percentage of the packets that have been returned from the host 140. Such computed delay is therefore adaptive to the backlog situation. For example, if presently there is no backlog (i.e., all or substantial number of the packets have been returned), the delay may be zero. If the host 140 is presently very backed up (e.g., a large percentage of the packets that are handed over previously are still not yet returned), the delay may be adaptively made longer. Based on this adaptive delay, the I/O controller 110 will not assert receive interrupt 220, for a period of time specified by the delay.

The host 140 includes a protocol stack 150 that may comprise a plurality of layers. Each layer of the protocol stack 150 processes relevant packets. Whenever a packet is processed, the protocol stack 150 notifies the I/O controller 110.

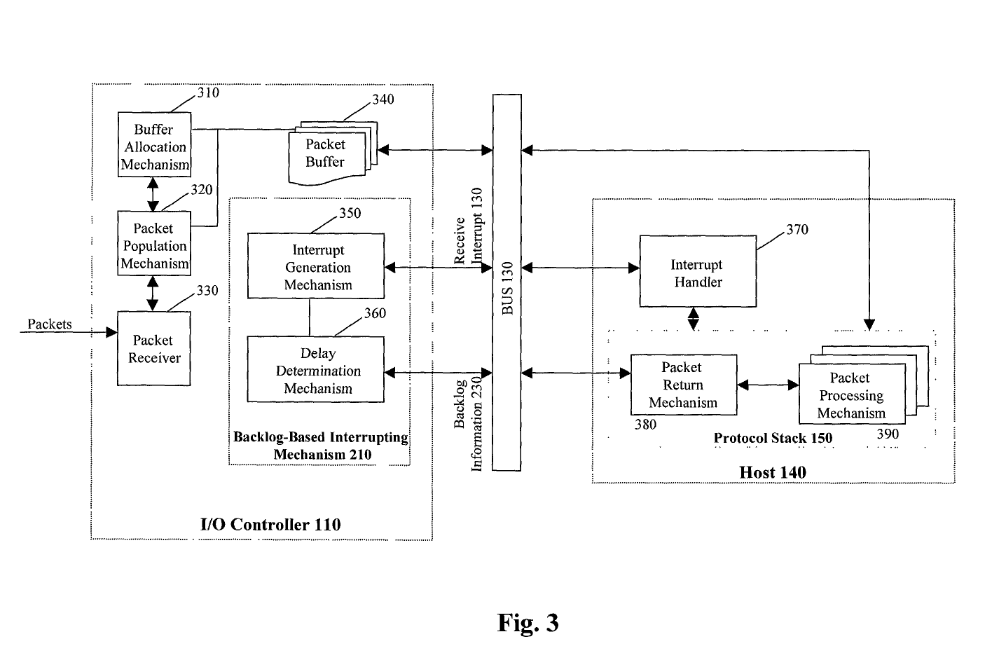

FIG. 3 depicts the internal structures of the I/O controller 110 in relation to the host 140 that provides backlog information 230 for the I/O controller 110 to determine an interrupt delay, according to embodiments of the present invention. The I/O controller 110 comprises a packet receiver 330, a buffer allocation mechanism 310, a packet population mechanism 320, a packet buffer 340, and the backlog-based interrupting mechanism 210. The buffer allocation mechanism 310 is responsible for allocating packet buffers that are used for storing received packets. The packer receiver 330 is responsible for receiving packets that are transferred to the I/O controller 110. Upon receiving such packets, the packet receiver 330 invoke the packet population mechanism 320 to populate the received packets in the packet buffer 340.

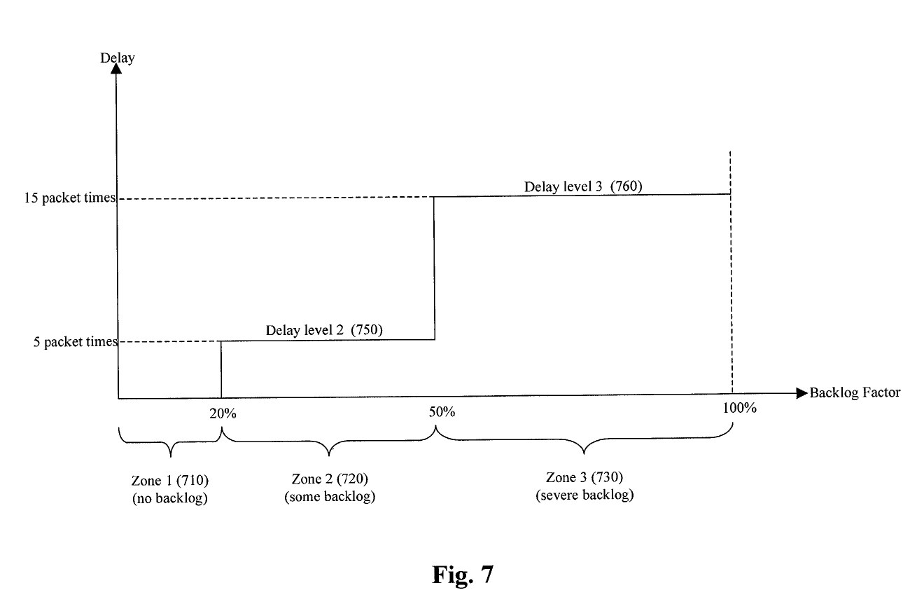

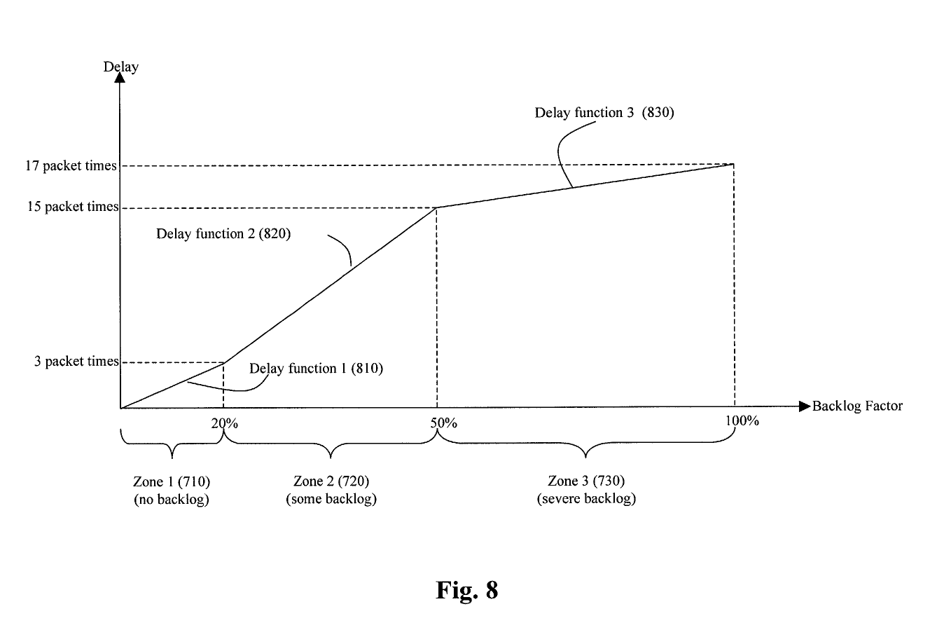

The backlog based interrupting mechanism 210 includes a delay determination mechanism 360 and an interrupt generation mechanism 350. The delay determination mechanism 360 gathers information related to the backlog situation of the host 140 (e.g., the percentage of the packets that have not been returned) and computes a delay accordingly. The relationship between backlog situation assessment and the computed delay may depend on application needs and may be captured using some functions. Detailed discussion related to the computation of a delay is presented later in referring to FIG. 7 and FIG. 8.

The interrupt generation mechanism 350 uses the computed delay to control when to generate next receive interrupt that notifies the host 140 about received packets. That is, the computed delay is enforced via the interrupt generation mechanism 350 by not generating next interrupt until the delay is satisfied. In such scenarios, the delay may serve as a timer.

The host 140 includes an interrupt handler 370 and a protocol stack 150, which may comprise a plurality of layers of processing mechanisms 390 and a packet return mechanism 380. When the interrupt handler 370 intercepts a receive interrupt, it notifies the protocol stack 150. Different layers of the packet processing mechanism 390 in the protocol stack 150 may then selectively process the packets that are available. When the processing on a particular packet is completed, the packet return mechanism 380 notifies the I/O controller 110 about the completion.

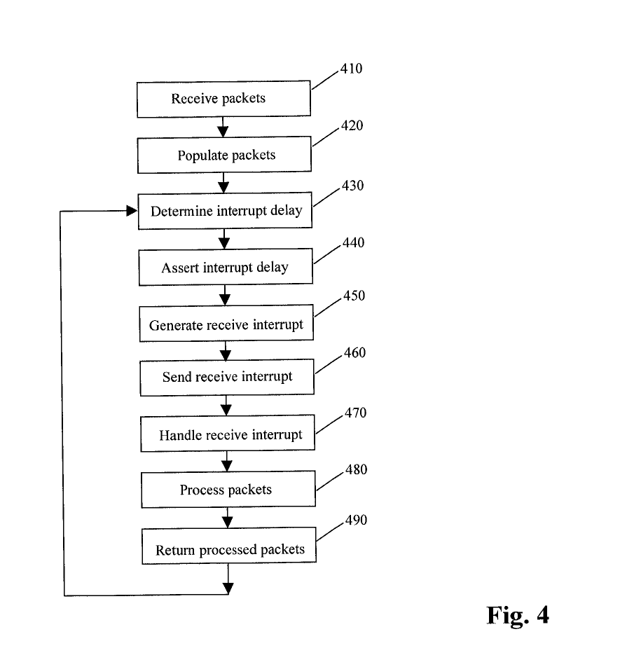

FIG. 4 is an exemplary flowchart of a process, in which an I/O controller and a host communicate about received packets via a receive interrupt with a delay that is adaptively adjusted based on the backlog situation of the host, according to embodiments of the present invention. Packets are received first at 410 and then populated, at 420, into the packet buffer. The I/O controller 110 then determines when to issue an interrupt to inform the host 140 about the received packet. To do so, the I/O controller 110 computes, at 430, the interrupt delay based on the backlog situation at the host 140. Such determined delay is then asserted at 440. When the delay is satisfied, the I/O controller 110 generates, at 450, a receive interrupt and asserts the interrupt, at 460, to the host 140. Upon intercepting the receive interrupt, the host 140 processes, at 480, the received packets and then returns, at 490, the processed packets to the I/O controller 110.

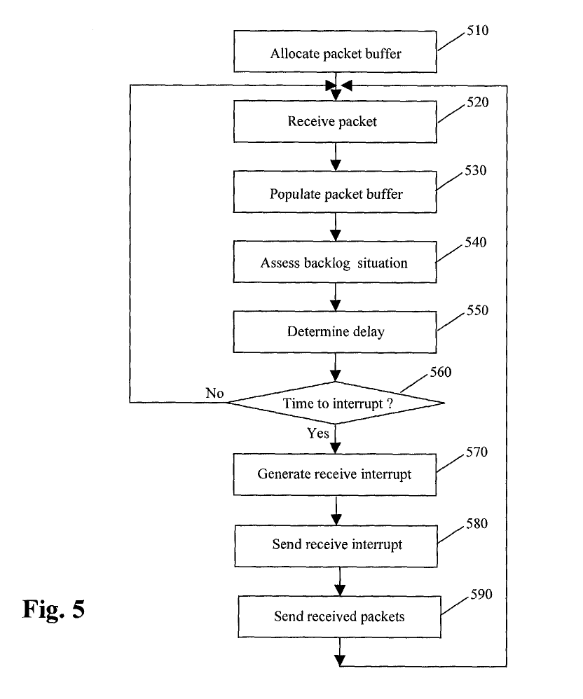

FIG. 5 is an exemplary flowchart of a process, in which the I/O controller 110 adaptively determines the delay based on the backlog situation of the host 140, according to embodiments of the present invention. A packet buffer is first allocated, at 510, for storing received packets. Packets are received at 520 and are populated in the packet buffer at 530. The backlog-based interrupting mechanism 210 then assesses, at 540, the backlog situation based on information related to returned packets. A delay is then accordingly determined at 550.

A receive interrupt will not be generated until the delay is satisfied. When the delay is not satisfied, determined at 560, the I/O controller 110 may keep receiving more packets and subsequently populating them in the packet buffer. When the delay is satisfied, the I/O controller 110 generates, at 570, a receive interrupt and sends, at 580, the interrupt to the host 140. The I/O controller 110 then sends, at 590, the received packets to the host 140.

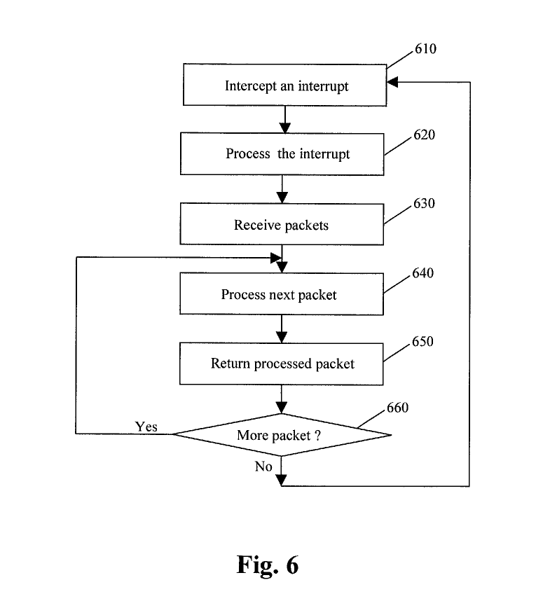

FIG. 6 is an exemplary flowchart of a process, in which the host 140 processes packets upon intercepting a receive interrupt and returns a processed packet to the I/O controller when the processing is completed. A receive interrupt is intercepted first at 610. The interrupt signal is then processed at 620. Being notified that there are more received packets, the host 140 receives, at 630, the packets. Various layers of the packet processing mechanism 390 in the protocol stack 150 then proceeds to process, at 640, the packets in the buffer. For each packet that is processed, the packet return mechanism 380 returns, at 650, the processed packet to the I/O controller 110. The process continues until all the packets have been processed, determined at 660.

As described earlier, a delay in the context of the present invention may be computed based on current backlog situation, which may be assessed according to, for example, the percentage of packets that have been returned from the host 140. Backlog may be classified into a plurality of zones, each of which may correspond to a different level of backlog severity. For example, zone 1 may correspond to the situation that there is no backlog or small degree of backlog. Zone 2 may correspond to a medium degree of backlog and zone 3 may correspond to a severe backlog situation. Number of such zones employed may depend on application needs. When a fewer number of zones are used, the computation required to compute the delay may be reduced. When a larger number of zones are used, the backlog-based interrupting mechanism 210 may be tuned at a finer resolution.

The backlog-based interrupting mechanism 210 may compute a delay with respect to zone classification. When backlog information is used to determine a delay, the severity of current backlog situation affects the amount of delay. For example, when there is no backlog, no delay is needed. When there is a severe backlog, a large delay is necessary. Therefore, for each zone, a different computation may be applied to accordingly determine the delay necessary for that zone. FIGS., 7 and 8 illustrate exemplary computation schemes to compute a delay based on backlog zone classification.

FIG. 7 is an exemplary plot of a plurality of constant functions, each of which represents a constant function used to compute a delay within a particular backlog zone, according to an embodiment of the present invention. In FIG. 7, the horizontal axis represents the severity of backlog and the vertical axis represents the amount of delay. There are three exemplary backlog zones illustrated, zone 1 (710), zone 2 (720), and zone 3 (730), corresponding to no backlog, some backlog, and severe backlog. Each zone may be defined according to certain percentage of packets that have not been returned. For example, zone 1 710 may be defined as having less than 20% of packets that have not been returned. That is, more than 80% of the packets have been returned. Similarly, zone 2 (720) may be defined as having more than 50% of the packets returned. The severe backlog zone (zone 3 730) may be defined as having only less than 50% of the packets returned.

In FIG. 7, a plurality of constant functions are depicted and they are used to compute the delay with respect to each zone. For example, a delay level 2 (750) (corresponding to a constant) is used for zone 2 (720). That is, if a backlog situation is classified as zone 2 (i.e., more than 50% but less than 80% of packets have been returned), the resultant delay is specified by the delay level 2 (750). In the exemplary illustration in FIG. 7, the delay level 2 corresponds to “5 packet times”, meaning a delay of next 5 packets (or alternatively, do not send a receive interrupt for the next 5 received packets). Similarly, if a backlog situation is classified as zone 3 (i.e., more than 50% of the packets are not yet returned), the resultant delay is defined by a different constant function with delay level 3 (760), corresponding to a delay of “15 packet times”.

Different functions, other than constant functions, may also be employed to map a backlog severity level to a delay value. For example, a linear function may be employed. While a constant function provides a single value within each zone and two constant functions across two zones may introduce a sharp jump (e.g., the difference between the delay level 2 and the delay level 3 in FIG. 6), a linear function may provide a continuous mapping between the severity of backlog and the delay value. In addition, it is possible to define linear functions in such a way that the transition between adjacent zones is smooth.

FIG. 8 is an exemplary plot of a plurality of linear functions, each of which represents a delay function within a particular backlog zone, according to an embodiment of the present invention. There are three linear functions illustrated (delay function 1 810, delay function 2 820, and delay function 3 830) that define mappings between backlog severity and delay values across three backlog zones (zone 1 710, zone 2 720, and zone 3 730). Each linear function maps a backlog severity to a delay value spanning from a lower bound delay value to an upper bound delay value. For example, the delay function 1 810 defines the mapping between a backlog severity value in zone 1 (710) and a delay value between no delay (or 0 delay) to a delay level of “3 packet times”. Similarly, the delay function 2 820 corresponds to a mapping, ranging from delay level “3 packet times” to “15 packet times”, that describes the relationship between a backlog severity level within zone 2 and a delay value between lower bound “3 packet times” and upper bound “15 packet times”.

Within each zone, a linear delay function proportionally maps a particular backlog to a delay level. That is, each different backlog severity will result in a different delay value. This is different from a constant mapping, where all backlog severity values within a same zone will result in a same delay value. Therefore, a linear delay function provides finer level of adaptivity.

In the illustrated example shown in FIG. 8, adjacent linear functions may be so designed that the transition between two adjacent zones is smooth. For example, since the upper bound of the delay function 2 820 (“15 packet times”) is the same as the lower bound of the delay function 3 830, the transition between zone 2 720 and zone 3 730 will be smooth.

In a particular implementation, constant functions and linear functions may be mixed across different backlog zones. In addition, non-linear functions may also be employed, either alone or together with constant or linear functions, to define the mapping between backlog severity level classifications and interrupt delays.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

What is claimed is:

1. A method, comprising:
receiving at least one packet;
issuing a receive interrupt with a delay, the delay being determined based on backlog information on a host, to inform the host about the received packets;
processing, upon receiving the receive interrupt, the received packets.

2. The method according to claim 1, wherein said issuing comprises:
determining the delay based on the backlog information gathered according to number of the processed packets that are returned from the host;
asserting the delay;
generating the receive interrupt, after the delay is asserted; and sending the receive interrupt to the host.

3. The method acording to claim 2, further comprising:
populating the at least one packet, after said receiving, into a packet buffer; and
sending the received packets in the packet buffer to the host for said processing.

4. A method for an input and output controller, comprising:
receiving at least one packet;
populating the at least one packet into a packet buffer;
issuing a receive interrupt with a delay, determined based on backlog information on a host, to inform the host about the received packets; and
sending the received packets to the host.

5. The method according to claim 4, wherein said issuing comprises:
gathering backlog information based on number of processed packets that are returned from the host;
determining the delay according to the backlog information;
asserting the delay;
generating the receive interrupt, after the delay is asserted; and
sending the receive interrupt to the host.

6. The method according to claim 5, wherein said determining the delay comprises:
determining a backlog zone using the backlog information; and
computing the delay based on a delay function for the backlog zone.

7. The method according to claim 6, wherein the delay function for the backlog zone includes at least one of:
a constant function with a constant pre-determined according to the backlog zone;
a linear function defined within the backlog zone; or
a non-linear function defined within the backlog zone.

8. The method according to claim 7, further comprising:
allocating the packet buffer prior to said receiving; and
populating the at least one packet into the packet buffer prior to said sending the received packets to the host.

9. A system, comprising:
an input and output controller for receiving packets and for notifying the received packets by sending a receive interrupt with an appropriate delay determined based on backlog information; and
a host for processing the received packets upon intercepting the receive interrupt and for returning processed packets to the input and output controller, from which the backlog information is determined.

10. The system according to claim 9, wherein said input and output controller comprises:
a packet receiver for intercepting the packets;
a packet buffer for storing the received packets; and
a backlog based interrupting mechanism for generating the receive interrupt, after the packets are populated in the packet buffer, based on the backlog information.

11. The system according to claim 10, wherein the backlog based interrupting mechanism comprises:
a delay determination mechanism for computing the appropriate delay based on the backlog information; and
an interrupt generation mechanism for generating the receive interrupt with the appropriate delay and for sending the receive interrupt and the received packets to the host.

12. The system according to claim 10, wherein the host comprises:
an interrupt handler for intercepting and processing the receive interrupt; and
a protocol stack with at least one layer for handling the received packets at appropriate layers.

13. The system according to claim 12, wherein said protocol stack comprises:
a packet processing mechanism for processing the received packets; and
a packet return mechanism for returning processed packets to the input and output controller.

14. An input and output controller, comprising:
a packet receiver for intercepting at least one packet;
a packet buffer for storing the received packets; and
a backlog based interrupting mechanism for issuing a receive interrupt with an appropriate delay, computed based on backlog information, to a host.

15. The system according to claim 14, wherein the delay-based interrupting mechanism comprises:
a delay determination mechanism for computing the appropriate delay according to the the backlog information; and
an interrupt generation mechanism for generating the receive interrupt with the appropriate delay and for sending the receive interrupt to the host.

16. The system according to claim 15, further comprising:
a buffer allocation mechanism for allocating the packet buffer; and
a packet population mechanism for populating the received packets into the packet buffer.

17. A machine-accessible medium encoded with data, the data, when accessed, causing:
receiving at least one packet;
issuing a receive interrupt with a delay, determined based on backlog information on a host, to inform the host about the received packets;
processing, upon receiving the receving interrupt, the received packets; and
returning processed packets to an input and output controller.

18. The medium according to claim 17, wherein said issuing comprises:
determining the delay based on the backlog information gathered according to number of the processed packets that are returned from the host;
asserting the delay;
generating the receive interrupt, after the delay is asserted; and
sending the receive interrupt to the host.

19. The medium acording to claim 18, the data, when accessed, further causing:
populating the at least one packet, after said receiving, into a packet buffer in the input and output controller;
intercepting the receive interrupt, prior to said processing; and
sending the received packets to the host for said processing.

20. A machine-accessible medium encoded with data for an input and output controller, the data, when accessed, causing:
receiving at least one packet;
populating the at least one packet into a packet buffer;
issuing a receive interrupt with a delay, determined based on backlog information on a host, to inform the host about the received packets; and
sending the received packets to a host.

21. The medium according to claim 20, wherein said issuing comprises:
gathering backlog information based on number of processed packets that are returned from the host;
determining the delay according to the backlog information;
asserting the delay;
generating the receive interrupt, after the delay is asserted; and
sending the receive interrupt to the host.

22. The medium according to claim 21, wherein said determining the delay comprises:
determining a backlog zone using the backlog information; and
computing the delay based on a delay function for the backlog zone.

23. The medium according to claim 22, wherein the delay function for the backlog zone includes at least one of:
a constant function with a constant pre-determined according to the backlog zone;
a linear function defined within the backlog zone; or
a non-linear function defined within the backlog zone.

24. The medium according to claim 23, the data, when accessed, further causing:
allocating the packet buffer prior to said receiving; and
populating the at least one packet into the packet buffer prior to said sending the received packets to the host.
